(19) United States
(12) Patent Application Publication
(10) Pub. No.: US 2005/0237908 A1
(43) Pub. Date: Oct. 27, 2005

(54) Method for arranging a vibration suppressing plate to be arranged on an arm of an actuator for a magnetic disc

(75) Inventors: Yasuo Takano, Tokyo (JP); Atsushi Ishiguro, Tokyo (JP); Keiji Aruga, Kawasaki (JP); Kei Funabashi, Kawasaki (JP); Kenji Tanaka, Tokyo (JP); Naoto Tsuchiya, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: KANSEISHA CO., LTD.; FUJITSU LIMITED; TOTOKU ELECTRIC CO., LTD.

(21) Appl. No.: 11/102,817

(22) Filed: Apr. 11, 2005

(30) Foreign Application Priority Data
Apr. 13, 2004 (JP) 2004-118358

(51) Int. Cl. G11B 7/08; G11B 33/08

(52) U.S. Cl. 369/247.1; 720/651; 720/684

(57) ABSTRACT

To provide a novel method for arranging a vibration suppressing plate to be arranged in an arm of a magnetic disc actuator, a method for arranging a vibration suppressing plate 3 to an arm 2, projected from a magnetic disc actuator 1, for retaining a magnetic head 63 on a tip end side, includes the following steps of: peeling a first one 5 of peelable members 5 and 6 from a planar adhesive member 7 provided on both surfaces of a both-sided adhesive member 4 with the peelable members 5 and 6, the both-sided adhesive member 4 having the same shape as a predetermined shape of the vibration suppressing plate 3; subsequently, applying, aligning and attaching to the vibration suppressing member 3 the planar adhesive member 7 from which the first peelable member 5 has been peeled and removed; subsequently, peeling the other peeling member 6 to form the vibration suppressing plate 3 having one surface attached to the both-sided adhesive member 4; and subsequently, aligning and attaching the vibration suppressing plate 3 in a predetermined position of the arm 2 to arrange the vibration suppressing plate 3 in the arm 2.

### BACKGROUND OF THE INVENTION

1. Field of the Invention

The present invention relates to arrange a vibration suppressing plate to be arranged on an arm of an actuator for a magnetic disc.

2. Background Art

In a hard disc 61 as shown in FIG. 1, a plurality of rotatable magnetic discs 62 each having a surface on which magnetic particles are provided are laminated on each other. A magnetic head 63 is brought into contact with or close to the laminated magnetic discs 62.

This magnetic head 63 is provided at a tip end of an actuator 1 for the magnetic discs. More specifically, a plurality of plate-like arms 2 are provided on the front side of the magnetic disc actuator 1 at predetermined distances in a vertical direction. A magnetic head holder portion 64 is provided at a tip end of each arm 2. A magnetic head 63 is provided at this magnetic head holder portion 64. Also, a joint portion 66 connected with a drive means 68 for driving (operating) the magnetic disc actuator 1 is provided on the rear side of the magnetic disc actuator 1.

Each magnetic head 63 is arranged to be brought into contact with or close to the surface side of the laminated magnetic discs 62. The magnetic head 63 is brought into contact with or close to any desired position on the surface of each magnetic disc 62 for changing a magnetic condition by the magnetic head 63 to write information or to read the information (magnetic condition) written in the position by the magnetic head 63.

As shown in FIG. 2, this magnetic disc actuator 1 is formed by precisely cutting a basic material made of aluminum. Reference numeral 65 designates an axial hole.

By the way, in the recent circumstances that a high speed process is demanded more and more in such devices, a weight reducing hole 67 as shown in FIG. 2 is formed in each arm 2 of the magnetic disc actuator 1 for reducing the weight of the magnetic disc actuator 1 to reduce an inertia moment and to attain the high speed access.

However, to the contrary, due to the fact that the weight reducing hole 67 is formed to reduce the rigidity of the arm 2, the arm 2 is vibrated by an aerial resistance in high speed rotations. Accordingly, there is a problem that the positioning precision of the magnetic head 63 is degraded in inverse proportion to the high speed rotations obtained by forming the weight reducing hole 67. A track pitch interval (TPI) has been improved year after year for the purpose of increasing a capacity of the magnetic discs 62. In the circumstances that the higher and higher precision is demanded in positioning the magnetic head 63, the reduction in positioning precision of the magnetic head 63 by the vibrations of the arm 2 is fatal.

Accordingly, the suppression of the vibration of the arm 2 has been researched and developed to propose a vibration suppressing plate 3 that may suppress the vibrations of the arm 2.

This vibration suppressing plate 3 is made of thin plate material such as stainless steel and is provided on at least one of top and bottom surfaces of the arm 2 with the weight reducing hole 67 being closed by the vibration suppressing plates 3 to thereby make it possible to impart the rigidity to the arm 2 while maintaining the light weight. Accordingly, this technique is innovative to make it possible to suppress the vibrations of the arm 2 even in rotations at a high speed and to attain the improvement in positioning precision of the magnetic head 63.

The present inventors have further researched and developed the vibration suppressing plate 3 to be disposed in the arm 2 of the magnetic disc actuator 1 and have researched and developed an innovative method for arranging a vibration suppressing plate to be arranged in the magnetic actuator arm.

### SUMMARY OF THE INVENTION

The essence of the invention will now be described with reference to the drawings.

According to a first aspect of the invention, there is provided a method for arranging a vibration suppressing plate 3 to an arm 2, projected from a magnetic disc actuator 1, for retaining a magnetic head 63 on a tip end side, comprising the following steps of:
peeling a first one 5 of peelable members 5 and 6 from a planar adhesive member 7 provided on both surfaces of a both-sided adhesive member 4 with the peelable members 5 and 6, the both-sided adhesive member 4 having the same shape as a predetermined shape of the vibration suppressing plate 3;
subsequently, applying, aligning and attaching to the vibration suppressing member 3 the planar adhesive member 7 from which the first peelable member 5 has been peeled and removed;
subsequently, peeling the other peeling member 6 to form the vibration suppressing plate 3 having one surface attached to the both-sided adhesive member 4; and
subsequently, aligning and attaching the vibration suppressing plate 3 in a predetermined position of the arm 2 to arrange the vibration suppressing plate 3 in the arm 2.

Also, according to a second aspect of the invention, in a method for arranging a vibration suppressing plate to an arm of a magnetic disc actuator according to the first aspect, a means for applying, aligning and attaching to the vibration suppressing plate 3 the planar adhesive member 7 from which the first peelable member 5 has been peeled and removed comprises a means for applying, aligning and attaching the vibration suppressing plate 3 to a recess portion 8 of a base plate 9 for fitting and fixing the vibration suppressing plate 3 in place.

Also, according to a third aspect of the invention, in a method for arranging a vibration suppressing plate to an arm of a magnetic disc actuator according to the second aspect, holes 14 are formed in the peelable member 6, whereas convex portions 11 with which the holes 14 are to be engaged are formed in the base plate 9, and the holes 14 are fitted with the convex portions 11 to thereby apply, align and attach to the vibration suppressing plate 3 the planar adhesive member 7 from which the first peelable member 5 has been peeled and removed.

Also, according to a fourth aspect of the invention, in a method for arranging a vibration suppressing plate to an arm of a magnetic disc actuator according to the first aspect, a means for applying, aligning and attaching to the vibration suppressing plate 3 the planar adhesive member 7 from which the first peelable member 5 has been peeled and removed comprises a means wherein a vibration suppressing plate 3 around which a positioning member 12 is provided is used as the vibration suppressing plate 3, positioning portions 13 and 14 are provided at the positioning member 12 and the peelable member 6, and the positioning portions 13 and 14 are aligned with each other to thereby apply, align and attach to the vibration suppressing plate 3 the planar adhesive member 7 from which the first peelable member 5 has been peeled and removed.

Also, according to a fifth aspect of the invention, in a method for arranging a vibration suppressing plate to an arm of a magnetic disc actuator according to the fourth aspect, holes 13 and 14 are formed as the positioning member 12 of the vibration suppressing plate 3 and the positioning portions 13 and 14 of the peelable member 6, respectively, whereas convex portions 11 with which the holes 13 and 14 are to be engaged are formed in the base plate 9, and the holes 13 and 14 are fitted with the convex portions 11 to thereby apply, align and attach to the vibration suppressing plate 3 the planar adhesive member 7 from which the first peelable member 5 has been peeled and removed.

Also, according to a sixth aspect of the invention, in a method for arranging a vibration suppressing plate to an arm of a magnetic disc actuator according to any one of the first to fifth aspects, a means for aligning and attaching to a predetermined position of the arm 2 the vibration suppressing plate 3 having one surface to which the both-sided adhesive member 4 is attached and for arranging the vibration suppressing plate 3 to the arm 2 comprises a means for arranging a base plate 16 provided with the vibration suppressing plate 3 at a bottom surface approaching position of the arm 2, subsequently approaching and moving at least one or both of the arm 2 and the vibration suppressing plate 3 and aligning and attaching the vibration suppressing plate 3 to the arm 2.

Also, according to a seventh aspect of the invention, in a method for arranging a vibration suppressing plate to an arm of a magnetic disc actuator according to any one of the first to fifth aspects, a means for aligning and attaching to a predetermined position of the arm 2 the vibration suppressing plate 3 having one surface to which the both-sided adhesive member 4 is attached and for arranging the vibration suppressing plate 3 to the arm 2 comprises a means for arranging the base plate 16 provided with the vibration suppressing plate 3 to a bottom surface approaching position of the arm 2, arranging to the top surface approaching position of the arm 2 a clamp plate 17 for clamping the arm 2 with the base plate 16, clamping the arm 2 between the base plate 16 and the clamp plate 17 and aligning and attaching the vibration suppressing plate 3 to the arm 2.

Also, according to an eighth aspect of the invention, in a method for arranging a vibration suppressing plate to an arm of a magnetic disc actuator according to any one of the first to fifth aspects, a means for aligning and attaching to a predetermined position of the arm 2 the vibration suppressing plate 3 having one surface to which the both-sided adhesive member 4 is attached and for arranging the vibration suppressing plate 3 to the arm 2 comprises a means for fitting and fixing the vibration suppressing plate 3 to a recess portion 15 of the base plate 16 where the recess portion 15 to which the vibration suppressing plate 3 is fitted and fixed is formed, and aligning, attaching and arranging the vibration suppressing plate 3 to the arm 2.

Also, according to a ninth aspect of the invention, in a method for arranging a vibration suppressing plate to an arm of a magnetic disc actuator according to the sixth aspect, a means for aligning and attaching to a predetermined position of the arm 2 the vibration suppressing plate 3 having one surface to which the both-sided adhesive member 4 is attached and for arranging the vibration suppressing plate 3 to the arm 2 comprises a means for fitting and fixing the vibration suppressing plate 3 to a recess portion 15 of the base plate 16 where the recess portion 15 to which the vibration suppressing plate 3 is fitted and fixed is formed, and aligning, attaching and arranging the vibration suppressing plate 3 to the arm 2.

According to a tenth aspect of the invention, in a method for arranging a vibration suppressing plate to an arm of a magnetic disc actuator according to the seventh aspect, a means for aligning and attaching to a predetermined position of the arm 2 the vibration suppressing plate 3 having one surface to which the both-sided adhesive member 4 is attached and for arranging the vibration suppressing plate 3 to the arm 2 comprises a means for fitting and fixing the vibration suppressing plate 3 to a recess portion 15 of the base plate 16 where the recess portion 15 to which the vibration suppressing plate 3 is fitted and fixed is formed, and aligning, attaching and arranging the vibration suppressing plate 3 to the arm 2.

According to an eleventh aspect of the invention, a method for arranging a vibration suppressing plate to an arm of a magnetic disc actuator according to the seventh aspect, further comprises the step of arranging to the bottom surface approaching position of the arm 2 the vibration suppressing plate 3 fitted and fixed to the recess portion 15 of the base plate 16, arranging the clamp plate 17 for clamping the arm 2 with the base plate 16 in the top surface approaching position of the arm 2, subsequently clamping the arm 2 between the base plate 16 and the clamp plate 17 and aligning, attaching and arranging the vibration suppressing plate 3 to the arm 2.

According to a twelfth aspect of the invention, a method for arranging a vibration suppressing plate to an arm of a magnetic disc actuator according to the eighth aspect, further comprises the step of arranging to the bottom surface approaching position of the arm 2 the vibration suppressing plate 3 fitted and fixed to the recess portion 15 of the base plate 16, arranging the clamp plate 17 for clamping the arm 2 with the base plate 16 in the top surface approaching position of the arm 2, subsequently clamping the arm 2 between the base plate 16 and the clamp plate 17 and aligning, attaching and arranging the vibration suppressing plate 3 to the arm 2.

According to a thirteenth aspect of the invention, a method for arranging a vibration suppressing plate to an arm of a magnetic disc actuator according to the ninth aspect, further comprises the step of arranging to the bottom surface approaching position of the arm 2 the vibration suppressing plate 3 fitted and fixed to the recess portion 15 of the base plate 16, arranging the clamp plate 17 for clamping the arm 2 with the base plate 16 in the top surface approaching position of the arm 2, subsequently clamping the arm 2 between the base plate 16 and the clamp plate 17 and aligning, attaching and arranging the vibration suppressing plate 3 to the arm 2.

According to a fourteenth aspect of the invention, a method for arranging a vibration suppressing plate to an arm of a magnetic disc actuator according to the tenth aspect, further comprises the step of arranging to the bottom surface approaching position of the arm 2 the vibration suppressing plate 3 fitted and fixed to the recess portion 15 of the base plate 16, arranging the clamp plate 17 for clamping the arm with the base plate 16 in the top surface approaching position of the arm 2, subsequently clamping the arm 2 between the base plate 16 and the clamp plate 17 and aligning, attaching and arranging the vibration suppressing plate 3 to the arm 2.

According to fifteenth aspect of the invention, in a method for arranging a vibration suppressing plate to an arm of a magnetic disc actuator according to the sixth aspect, the base plate 16 is set to such a thickness that the base plate 16 may be arranged between a plurality of juxtaposed arms 2.

According to a sixteenth aspect of the invention, in a method for arranging a vibration suppressing plate to an arm of a magnetic disc actuator according to the seventh aspect, the base plate 16 is set to such a thickness that the base plate 16 may be arranged between a plurality of juxtaposed arms 2.

According to a seventeenth aspect of the invention, in a method for arranging a vibration suppressing plate to an arm of a magnetic disc actuator according to the eighth aspect, the base plate 16 is set to such a thickness that the base plate 16 may be arranged between a plurality of juxtaposed arms 2.

According to an eighteenth aspect of the invention, in a method for arranging a vibration suppressing plate to an arm of a magnetic disc actuator according to the ninth aspect, the base plate 16 is set to such a thickness that the base plate 16 may be arranged between a plurality of juxtaposed arms 2.

According to a nineteenth aspect of the invention, in a method for arranging a vibration suppressing plate to an arm of a magnetic disc actuator according to the tenth aspect, the base plate 16 is set to such a thickness that the base plate 16 may be arranged between a plurality of juxtaposed arms 2.

According to a twentieth aspect of the invention, in a method for arranging a vibration suppressing plate to an arm of a magnetic disc actuator according to the eleventh aspect, the base plate 16 is set to such a thickness that the base plate 16 may be arranged between a plurality of juxtaposed arms 2.

According to a twenty-first aspect of the invention, in a method for arranging a vibration suppressing plate to an arm of a magnetic disc actuator according to the twelfth aspect, the base plate 16 is set to such a thickness that the base plate 16 may be arranged between a plurality of juxtaposed arms 2.

According to a twenty-second aspect of the invention, in a method for arranging a vibration suppressing plate to an arm of a magnetic disc actuator according to the thirteenth aspect, the base plate 16 is set to such a thickness that the base plate 16 may be arranged between a plurality of juxtaposed arms 2.

According to a twenty-third aspect of the invention, in a method for arranging a vibration suppressing plate to an arm of a magnetic disc actuator according to the fourteenth aspect, the base plate 16 is set to such a thickness that the base plate 16 may be arranged between a plurality of juxtaposed arms 2.

According to a twenty-fourth aspect of the invention, in a method for arranging a vibration suppressing plate to an arm of a magnetic disc actuator according to the sixth aspect, the clamp plate 17 is set to such a thickness that the clamp plate 17 may be arranged between a plurality of juxtaposed arms 2.

According to a twenty-fifth aspect of the invention, in a method for arranging a vibration suppressing plate to an arm of a magnetic disc actuator according to the seventh aspect, the clamp plate 17 is set to such a thickness that the clamp plate 17 may be arranged between a plurality of juxtaposed arms 2.

According to a twenty-sixth aspect of the invention, in a method for arranging a vibration suppressing plate to an arm of a magnetic disc actuator according to the eighth aspect, the clamp plate 17 is set to such a thickness that the clamp plate 17 may be arranged between a plurality of juxtaposed arms 2.

According to a twenty-seventh aspect of the invention, in a method for arranging a vibration suppressing plate to an arm of a magnetic disc actuator according to the ninth aspect, the clamp plate 17 is set to such a thickness that the clamp plate 17 may be arranged between a plurality of juxtaposed arms 2.

According to a twenty-eighth aspect of the invention, in a method for arranging a vibration suppressing plate to an arm of a magnetic disc actuator according to the tenth aspect, the clamp plate 17 is set to such a thickness that the clamp plate 17 may be arranged between a plurality of juxtaposed arms 2.

According to a twenty-ninth aspect of the invention, in a method for arranging a vibration suppressing plate to an arm of a magnetic disc actuator according to the eleventh aspect, the clamp plate 17 is set to such a thickness that the clamp plate 17 may be arranged between a plurality of juxtaposed arms 2.

According to a thirtieth aspect of the invention, in a method for arranging a vibration suppressing plate to an arm of a magnetic disc actuator according to the twelfth aspect, the clamp plate 17 is set to such a thickness that the clamp plate 17 may be arranged between a plurality of juxtaposed arms 2.

According to a thirty-first aspect of the invention in a method for arranging a vibration suppressing plate to an arm of a magnetic disc actuator according to the thirteenth aspect, the clamp plate 17 is set to such a thickness that the clamp plate 17 may be arranged between a plurality of juxtaposed arms 2.

According to a thirty-second aspect of the invention, in a method for arranging a vibration suppressing plate to an arm of a magnetic disc actuator according to the fourteenth aspect, the clamp plate 17 is set to such a thickness that the clamp plate 17 may be arranged between a plurality of juxtaposed arms 2.

With such a structure according to the present invention, it is possible to provide a novel method for arranging a vibration suppressing plate to be arranged in an arm of a magnetic disc actuator, which may arrange to the magnetic disc actuator the vibration suppressing plate for suppressing vibration generated in the arm.

### BRIEF DESCRIPTION OF THE DRAWINGS

FIG. 1 is a perspective view illustrative of a hard disc.

FIG. 2 is a plan view illustrative of a magnetic disc actuator.

FIG. 3 is an exploded perspective view illustrative of a both-sided adhesive member.

FIG. 4 is a view illustrative of a process according to a first embodiment.

FIG. 5 is another view illustrative of a process according to the first embodiment.

FIG. 6 is still another view illustrative of a process according to the first embodiment.

FIG. 7 is still another view illustrative of a process according to the first embodiment.

FIG. 8 is still another view illustrative of a process according to the first embodiment.

FIG. 9 is still another view illustrative of a process according to the first embodiment.

FIG. 10 is still another view illustrative of a process according to the first embodiment.

FIG. 11 is still another view illustrative of a process according to the first embodiment.

FIG. 12 is still another view illustrative of a process according to the first embodiment.

FIG. 13 is still another view illustrative of a process according to the first embodiment.

FIG. 14 is still another view illustrative of a process according to the first embodiment.

FIG. 15 is a perspective view showing a condition that a vibration suppressing plate is arranged to an arm of the magnetic disc actuator.

FIG. 16 is a view illustrative of a process according to the second embodiment.

### BEST MODE FOR EMBODYING THE INVENTION

A best mode for embodying the invention will now be described while showing the effect of the invention with reference to the accompanying drawings.

According to the invention, in arranging a vibration suppressing plate 3 to each arm 2 of a magnetic disc actuator 1, one of peelable members 5 is peeled apart from a planar adhesive member 7 having both surfaces on which peelable members 5 and 6 having the same shape as that of the vibration suppressing plate 3 having a predetermined shape are provided; subsequently, a both-sided adhesive member 4 of the planar adhesive member 7 from which one of the peelable members 5 has been removed is aligned and bonded with the vibration suppressing plate 3; subsequently, the other peelable member 6 is peeled off to form the vibration suppressing plate 3 having one surface on which the both-sided adhesive member 4 has been bonded; and subsequently, this vibration suppressing plate 3 is bonded in a predetermined position of the arm 2 to arrange the vibration suppressing plate 3 to the arm 2.

It is therefore possible to positively and effectively arrange the vibration suppressing plate 3 to the arm 2 of the magnetic disc actuator 1.

### Embodiment 1

A specific embodiment 1 of the present invention will now be described with reference to the drawings.

The present embodiment is directed to a method for arranging the vibration suppressing plate 3 to be arranged in each arm 2 of the magnetic disc actuator 1.

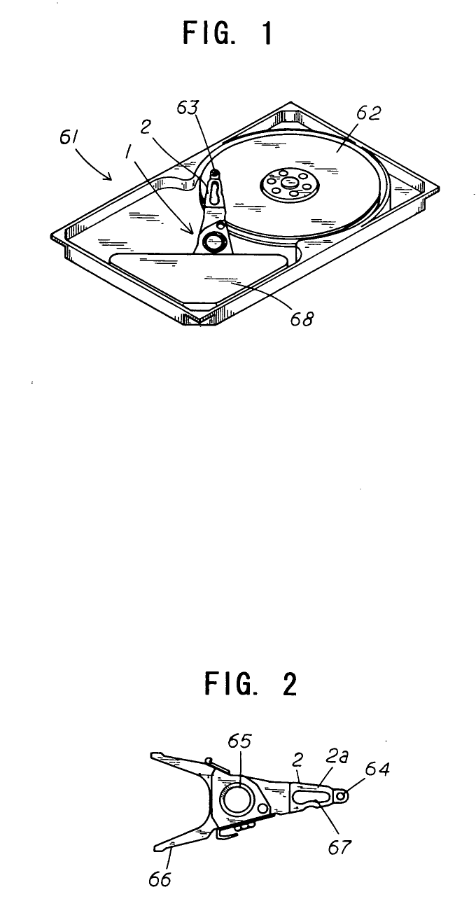

The structure of the magnetic disc actuator 1 is well known as described above and is formed by precisely cutting basic material of aluminum as shown in FIG. 2. More specifically, a plurality of planar arms 2 each provided with the magnetic head holder portion 64 at the front side thereof are provided in the laminated condition (multi-stage condition) in the vertical direction, and a pair of joint portions 66 connected to a drive means 68 are provided on the rear side. Reference numeral 65 designates an axial hole.

In case of the embodiment shown in the drawings, a plurality (five) of arms 2 each having a weight reduction hole 67 are juxtaposed at predetermined intervals. Predetermined top and bottom surface positions of the arms 2 having the weight reduction holes 67 are used as a vibration plate retaining portion 2a where the vibration suppressing plate 3 to be described later is to be disposed. Incidentally, the shape or the number of the arms 2 is subjected to be designed around as desired.

The vibration suppressing plate 3 is formed of a thin plate made of stainless steel as shown in FIG. 4 (like a film). The vibration suppressing plate 3 is formed to have substantially the same contour as that of the vibration suppressing retaining portion 2a of the arm 2 and to have such a size that at least weight reducing hole 67 is closed when the vibration suppressing plate 3 is arranged in the vibration suppressing plate arrangement portion 2a.

This vibration suppressing plate 3 is arranged through a planar adhesive member 7 in the vibration suppressing plate retaining portion 2a.

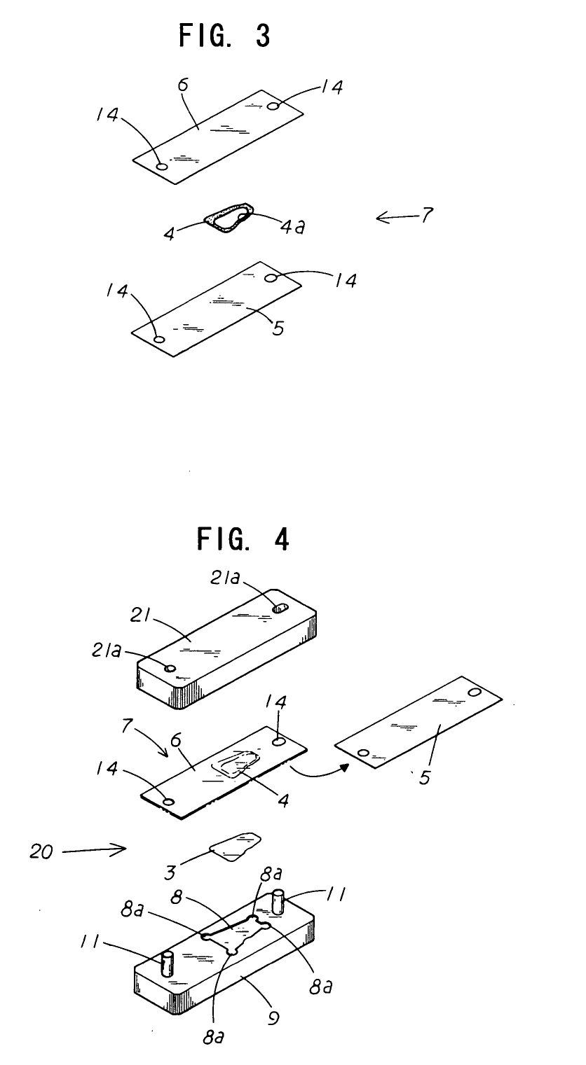

As shown in FIG. 3, the planar adhesive member 7 is composed of a both-sided adhesive member 4 in which adhesive layers are formed on both top and bottom surfaces of a resin made film and peelable members 5 and 6 formed of resin made films provided on both sides of the both-sided adhesive member 4.

The both-sided adhesive member 4 has the same shape as that of the above-described vibration suppressing plate 3. A hole 4a having the similar shape as that of the weight reducing member 67 is formed in the middle of the both-sided adhesive member 4.

At least one pair of holes 14 are formed at both ends of each peelable member 5, 6, respectively. The holes 14 fit at convex portions 11 (pins) provided on an adhesive member applying device 20 to be described later to thereby function as a positioning portion 14 for the both-sided adhesive member 4.

Although not shown, it is possible to use a system in which a plurality of rolls of planar adhesive members 7 are provided and the planar adhesive member 7 is separated from the other and used as the planar adhesive member 7. In particular, this system is suitable for the continuous work.

Also, in this embodiment, the adhesive applying device 20 for aligning and attaching the planar adhesive members 7, from which one of the above-described peelable members 5 has been removed, to the vibration suppressing plate 3 and a vibration suppressing plate aligning and attaching device 30 for arranging to the vibration suppressing plate retaining portion 2a of the arm 2 the vibration suppressing plate 3 whose one surface is aligned and attached with the both-sided adhesive member 4 are provided.

First of all, the adhesive member applying device 20 will be described.

As shown in FIG. 4, the adhesive member applying device 20 is composed of a pair of upper and lower base plates 9 and 21. The pins (convex portions) 11 are provided at both end portions of the top surface of the lower base plate 9. On the other hand, a pair of holes 21a that may engage with the pins (convex portions) 11 of the above-described base plate 9 are formed in both end portions of the upper base plate 21. Incidentally, one of the holes 21a of the pair of holes 21a provided in the base plate 21 is formed into an oblong hole for smoothly performing the engagement with the pair of convex portions 11.

Accordingly, when the holes 21a of the base plate 21 are fitted with the convex portions 11 of the base plate 9 and the base plates 9 and 21 are attached together, the top surface of the base plate 9 and the bottom surface of the base plate 9 are brought into contact with each other.

Also, the pair of convex portions 11 provided in the base plate 9 are formed to have such an interval and a diameter that the convex portions 11 may engage with the pair of holes 14 provided in the peelable members 5 and 6 of the above-described planar adhesive member 7, respectively. The convex portions 11 are fitted with the holes 14 of the peelable members 5 and 6 so that the both-sided adhesive member 4 is positioned at a predetermined position of the base plate 9.

Also, as shown in FIG. 4, a recess portion 8 is formed at a predetermined position on the top surface of the base plate 9. The recess portion 8 is formed into the similar shape to the vibration suppressing plate 3 as viewed in plan view so that the vibration suppressing plate 3 may be fitted and fixed thereto.

Accordingly, when the vibration suppressing plate 3 is arranged in the recess portion 8, the vibration suppressing plate 3 is held in a positioned condition where the vibration suppressing plate 3 is not displaced at the predetermined position.

Also, the recess portion 8 is formed so that the vibration suppressing plate 3 fitted and fixed to the recess portion 8 and the both-sided adhesive member 4 are aligned with each other in shape.

Burrs are formed at edges of the vibration suppressing plate 3. Reference numeral 8a designates escape portions for allowing a cutting tool such as a cutter for cutting the burrs to escape from the corner portions when the burrs are to be removed.

With the adhesive applying device 20 having such a construction, the vibration suppressing plate 3 is fitted and fixed to the recess portion 8 of the base plate 9; the planer adhesive member 7 from which one of the peelable members 5 is peeled and removed is disposed in the base plate 9 while fitting the holes 14 of the peelable member 6 to the convex portions 11 of the peelable member 9; under this condition, the holes 21a of the base plate 21 are fitted to the convex portions 11 of the base plate 9 from above; and the both-sided adhesive member 4 is attached together to the top surface of the vibration suppressing plate 3 while being clamped by the base plate 9 and the base plate 21. In this case, the both-sided adhesive member 4 of the planar adhesive member 7 is positioned by the convex portions 11 of the base plate 9 and the holes 14 of the peelable member 6, and the vibration suppressing plate 3 is positioned by the recess portion 8 of the base plate 9, so that the both-sided adhesive member 4 is suitably attached together and adhered without any displacement from the vibration suppressing member 3.

The aligning and attaching device 30 will now be described.

The vibration suppressing plate aligning and attaching device 30 is composed of an actuator supporter 31, a vibration suppressing plate supporter 32 and a presser 45.

As shown in FIGS. 8 to 10, the actuator supporter 31 is constructed so that an actuator support portion 34 is implanted on a top surface of a base member 33.

A slide surface 33a sliding a guide portion 41 provided to the vibration suppressing plate supporter 32 to be described later is formed on one side of the base member 33.

A pair of rod members 35 is provided on a top rear portion of the base member 33. The rod members 35 are constructed so as to support a joint portion 66 of the magnetic disc actuator 1 that is to be moved up and down by the actuator support portion 34 to be described later.

Also, the base plate 33 is subjected to a smooth flat surface process on its lower surface and adapted so as to be slidingly moved along and on a flat top surface 39a of a base plate 39 constituting the vibration suppressing plate supporter 32 to be described later.

A cylindrical member 36 having a cylindrical shape and which may fit with the axial hole 65 of the magnetic disc actuator 1 is implanted in the central position of the top surface of the base member 33 in the actuator support portion 34. A setter 37 is provided at the upper portion of this cylindrical member 36. The magnetic disc actuator 1 which is fitted to the cylindrical member 36 through the axial hole 65 is set to the setter 37.

The setter 37 is fitted so as to be slidingly movable up and down under the condition that it is not pulled apart from the cylindrical member 36. The setter 37 is always biased upwardly by a biasing member 38 (coiled spring) to be fitted to the cylindrical member 36.

Accordingly, the magnetic disc actuator 1 set to the setter 37 is movable up and down along the cylindrical member 36. The magnetic disc actuator 1 is moved downwardly against the biasing member 38. The force for moving the magnetic disc actuator 1 downwardly is released so that the actuator 1 is moved upwardly by the biasing member 38.

Incidentally, the elevator mechanism for this actuator supporter 31 functions when the vibration suppressing plate 3 is arranged in the arm 2 to be described later and also functions as a height adjustment mechanism when the base plate 16 is arranged between the juxtaposed arms 2.

As shown in FIGS. 8 to 10, the vibration suppressing plate supporter 32 is constructed by providing the vibration suppressing plate support portion 40 on the top surface of the base plate 39.

The top surface 39a of the base plate 39 is subjected to the smooth flat process. The above-described actuator supporter 31 may slidingly move along the smooth flat top surface 39a. Furthermore, the guide portion 41 for guiding the actuator supporter 31 slidingly moving is provided in a predetermined position of the smooth flat top surface 39a.

This guide portion 41 is composed of a longitudinal member 41a and a lateral member 41b connected vertically to a tip end portion of the longitudinal member 41a. The slide surface 33a of the above-described actuator supporter 31 is guided by the longitudinal member 41a so that the actuator supporter 31 may be moved back and forth while limiting its movement on one side. When the end face of the actuator supporter 31 that has been forwarded up to a predetermined position is brought into contact with the lateral member 41b, the forward movement of the actuator supporter 31 is limited.

The forward movement of the actuator supporter 31 is limited by the lateral member 41b when the vibration suppressing plate retaining portion 2a of the arm 2 of the magnetic disc actuator 1 is arranged in a confronting position of the recess portion 15 provided in the base plate 16 of the vibration suppressing support portion 40.

The vibration suppressing support portion 40 is constructed by providing a pair of base portions 42 and 43 in positions where the guide portion 41 is interposed in a predetermined top surface position of the base plate 39, and by providing the base plate 16 between stepped portions 42a and 43a formed in upper portions of each respective base portions 42 and 43.

The base plate 16 is set to such a thickness that the base plate 16 may be arranged between a plurality of juxtaposed arms 2 in the above-described magnetic disc actuator 1. The actuator supporter 31 is moved forward along the guide portion 41 so that the base plate 16 may be disposed between the upper and lower arms 2.

Also, the recess portion 15 is provided in the central position of the top surface of the base plate 16. The recess portion 15 is formed to have the same shape in plan view as that of the vibration suppressing plate 3 so that the vibration suppressing plate 3 may be fitted and fixed thereto.

Accordingly, when the vibration support plate 3 is arranged in the recess portion 15, the vibration suppressing plate 3 is positioned without any displacement.

Also, when the actuator supporter 31 is moved forward along the guide portion 41 and the forward movement is limited, the recess portion 15 is arranged below the vibration suppressing plate retaining portion 2a of the arm 2 of the magnetic disc actuator 1.

Accordingly, when the vibration suppressing plate 3 is disposed in the recess portion 15 and under this condition, the actuator supporter 31 is moved forward up to the predetermined position, the vibration suppressing plate 3 is arranged below the vibration suppressing plate retaining portion 2a of the arm 2 of the magnetic disc actuator 1.

Also, the small L-shaped stepped portions 42b and 43b are formed along the top edge portions of the pair of base portions 42 and 43. The small stepped portions 42b and 43b are formed as guide portions 42b and 43b for guiding the presser 45 to be described later.

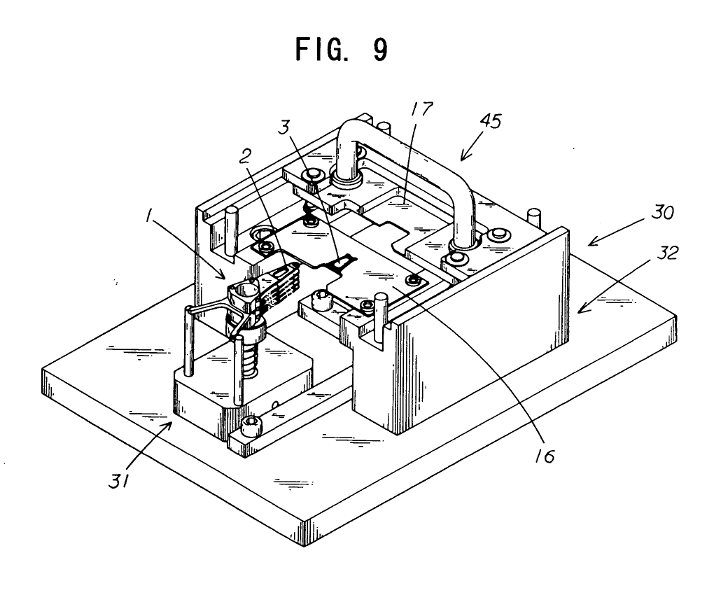

As shown in FIGS. 8 and 9, the presser 45 is composed of a slide member 46 and a presser body 47 connected to the slide member 46.

The slide member 46 is a suitable planar member and provided slidably between the above-described small stepped portions 42b and 43b and is adapted to be moved horizontally to the position above the base plate 16 when the slide member 46 is moved forward while a handle 50 to be described later is being held. Reference numeral 51 denotes movement limiting members for limiting the forward movement of the slide member 46.

The presser 47 is a suitable planar member and has holes (not shown) for fitting with four posts 48 suspending from predetermined positions of the bottom surface of the slide member 46. The presser 47 is movable up and down along the posts 48 and is always biased upwardly by biasing members 49 (coiled springs) arranged between the lower portions of the respective posts 48 and the bottom surface of the presser member 47.

Accordingly, the presser member 47 may be moved back and forth in the horizontal direction by holding the handle 50 provided on the top surface thereof and may be descended downwardly against the biasing members 49 by depressing the handle 50. If the pressure for depressing the handle 50 is released, the presser member 47 is raised upwardly by the biasing members 49.

An opening portion 47a is formed in the middle of the presser member 47. A clamp plate 17 is provided in the opening portion 47a.

The clamp plate 17 is set to such a thickness that the clamp plate 17 may be arranged between the plurality of arms 2 juxtaposed in the above-described magnetic disc actuator 1. The slide member 46 is moved forward so that the clamp plate 17 is disposed between the upper and lower arms 2.

When the clamp plate 17 is moved horizontally (forwardly), the clamp plate 17 is set so as to be arranged in a confronting position with the top surface of the arm 2 whose bottom surface is arranged in confronting position with the above-described base plate 16.

Accordingly, when the base plate 16 and the clamp plate 17 are arranged in the bottom surface confronting position and the top surface confronting position of the arm 2 of the magnetic disc actuator 1 and under this condition, the handle 50 is depressed to lower the clamp plate 17, the clamp member 17 depresses the top surface of the arm 2 to lower the magnetic disc actuator 1 so that the arm 2 is also lowered. The lowered arm 2 is brought into contact with the top surface (recess portion 15) of the base plate 16 so that the arm 2 may be clamped by the base plate 16 and the clamp plate 17. In this case, if the vibration suppressing plate 3 in which the both-sided adhesive member 4 has been attached together to the recess portion 15 of the base plate 16 is fitted and fixed thereto, it is possible to adhere and arrange the vibration suppressing plate 3 to the vibration suppressing plate retaining portion 2a of the arm 2.

In this embodiment, the arm 2 may be clamped by the base plate 16 and the clamp plate 17 by lowering the clamp plate 17 and the arm 2 of the magnetic disc actuator 1. However, it is possible to adopt such structure that the arm 2 is clamped by the base plate 16 and the clamp plate 17 by lowering the clamp plate 17 and raising the base plate 16.

A method of arranging the vibration suppressing plate 3 to the arm 2 of the magnetic disc actuator 1 using the adhesive applying device 20 and the vibration suppressing plate aligning and attaching device 30 with the above-described structure will now be described.

First of all, the vibration suppressing plate 3 having one surface to which the both-sided adhesive member 4 is attached is formed by using the adhesive applying device 20.

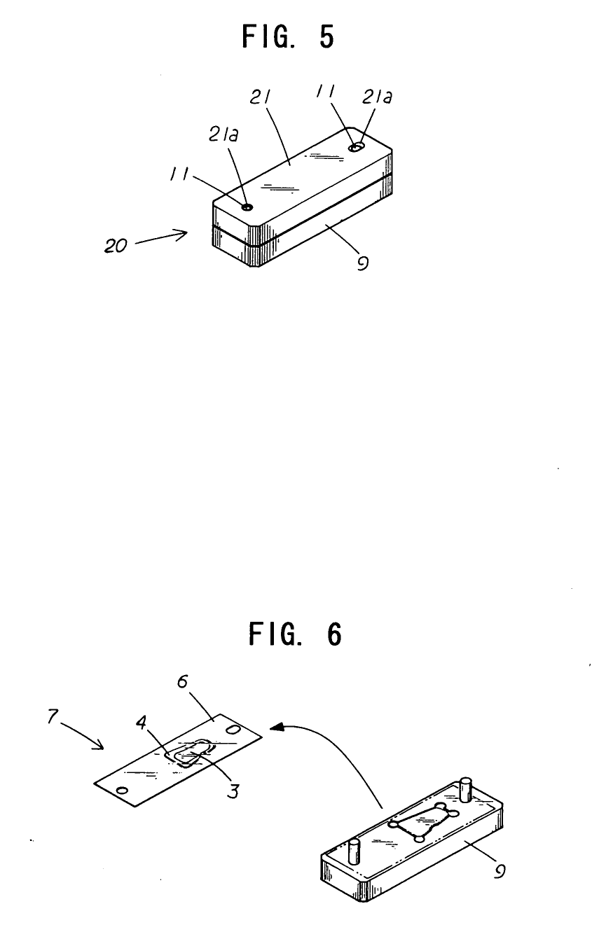

More specifically, the vibration suppressing plate 3 is fitted in and fixed to the recess portion 8 of the base plate 9; under this condition, the holes 14 of one of the peelable members 6 from which the other of the peelable members 5 is removed are fitted to the convex portions 11 of the base plate 9 so that the both-sided adhesive member 4 is attached together to the vibration suppressing plate 3; furthermore, the holes 21a of the base plate 21 are fitted to the convex portions 11 of the base plate 9 to bring the base plate 9 and the base plate 21 into the aligned and attached condition; and the both-sided adhesive member 4 aligned and attached to the vibration suppressing plate 3 is firmly attached by sufficiently pressing and clamping the both-sided adhesive member 4 with the base plate 9 and the base plate 21 (see FIGS. 4 and 5).

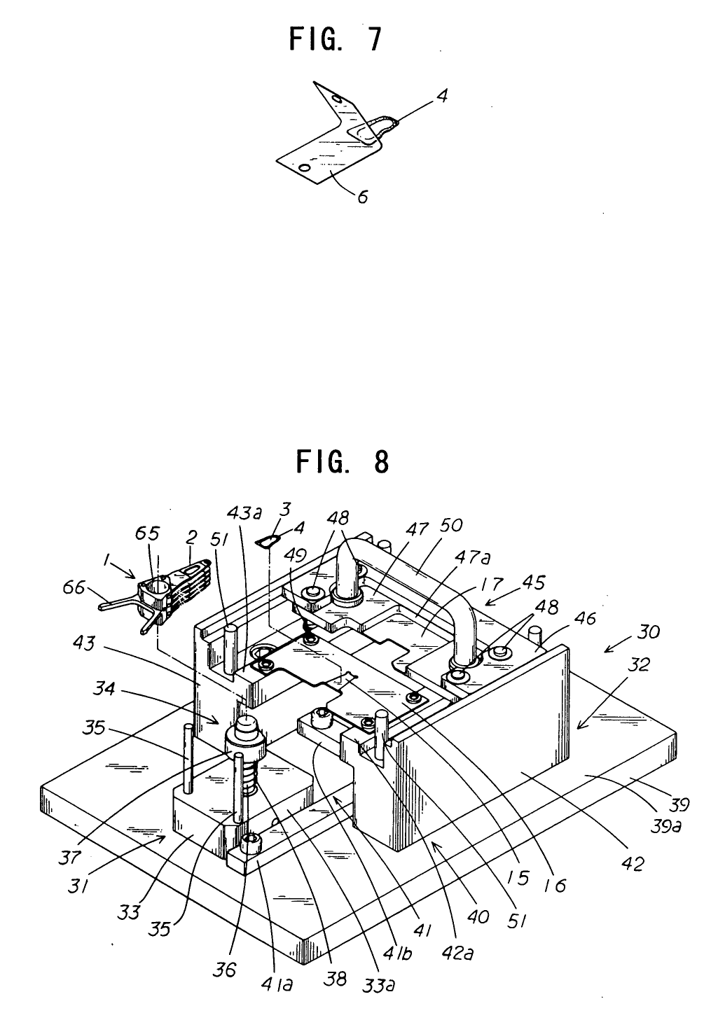

Thereafter, when the base plate 21 is removed from the base plate 9 to peel and remove the peelable member 6, the vibration suppressing plate 3 having one surface to which the both-sided adhesive member 4 is attached is obtained (see FIGS. 6 and 7).

Subsequently, the vibration suppressing plate 3 is aligned and attached to the arm 2 of the magnetic disc actuator 1 using the vibration suppressing plate aligning and attaching device 30. Incidentally, in this embodiment, the case where the vibration suppressing plate 3 is to be attached to the bottom surface (vibration suppressing plate retaining portion 2a) of the fourth arm 2 from above out of the five juxtaposed arms 2 will be described.

More specifically, the magnetic disc actuator 1 is set to the actuator supporter 31, and at the same time, the vibration suppressing plate 3 having one surface to which the both-sided adhesive member 4 has been aligned and attached is fitted in and fixed to the recess portion 15 of the base plate 16 relating to the vibration suppressing plate supporter 32. In this case, the surface to which the both-sided adhesive member 4 has been aligned and attached is used as the top surface (FIGS. 8 and 9).

Subsequently, when the actuator supporter 31 is guided by the guide portion 41 and moved forward up to the predetermined position where the movement is limited, the base plate 16 is arranged between the forth arm 2 and the fifth arm 2 from above. The vibration suppressing plate 3 to be fitted in and fixed to the recess portion 15 of the base plate 16 is inserted and arranged in the confronting approaching position of the bottom surface (vibration suppressing plate retaining portion 2a) of the fourth arm 2. When the base plate 16 is to be inserted and arranged between the arms 2, the height adjustment is performed by suitably ascending and descending the magnetic disc actuator 1 so that the base plate 16 is well inserted and arranged between the fourth arm 2 and the fifth arm 2.

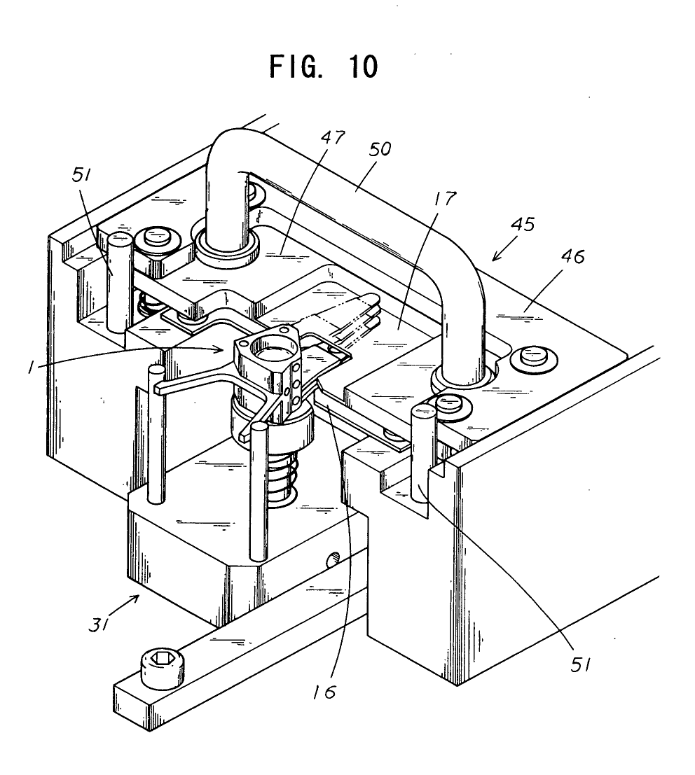

Subsequently, when the presser 45 which has been retracted back is guided by the guide portions 42b and 43b and moved forward to the predetermined position where the movement is limited by holding the handle 50, the clamp plate 17 of the presser 45 is inserted between the third arm 2 and the fourth arm 2 (see FIG. 10).

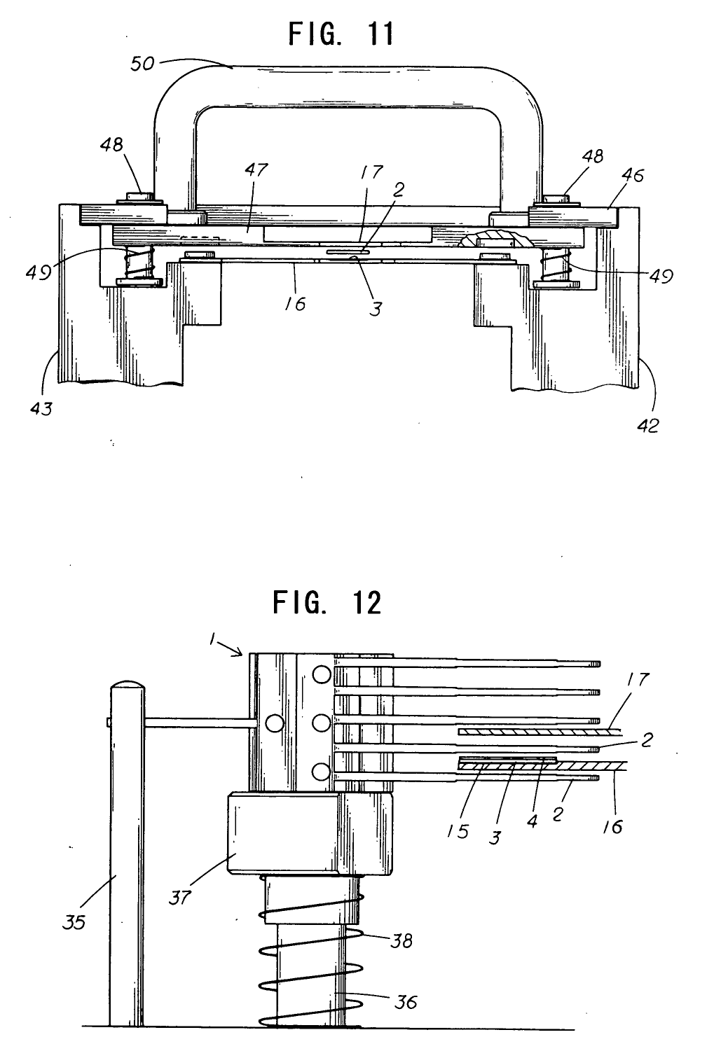

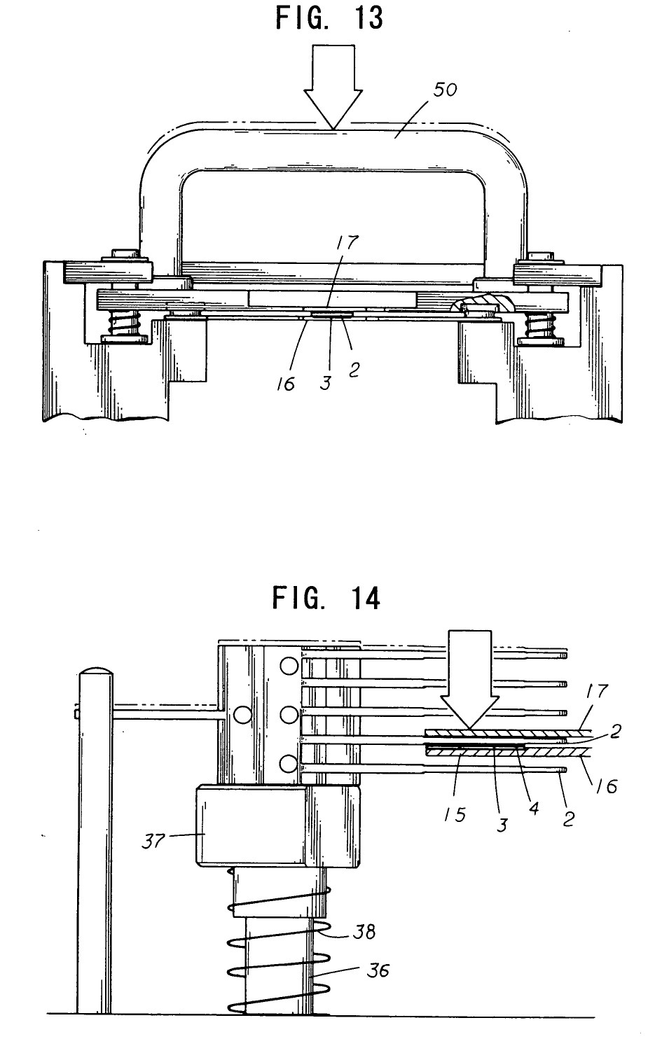

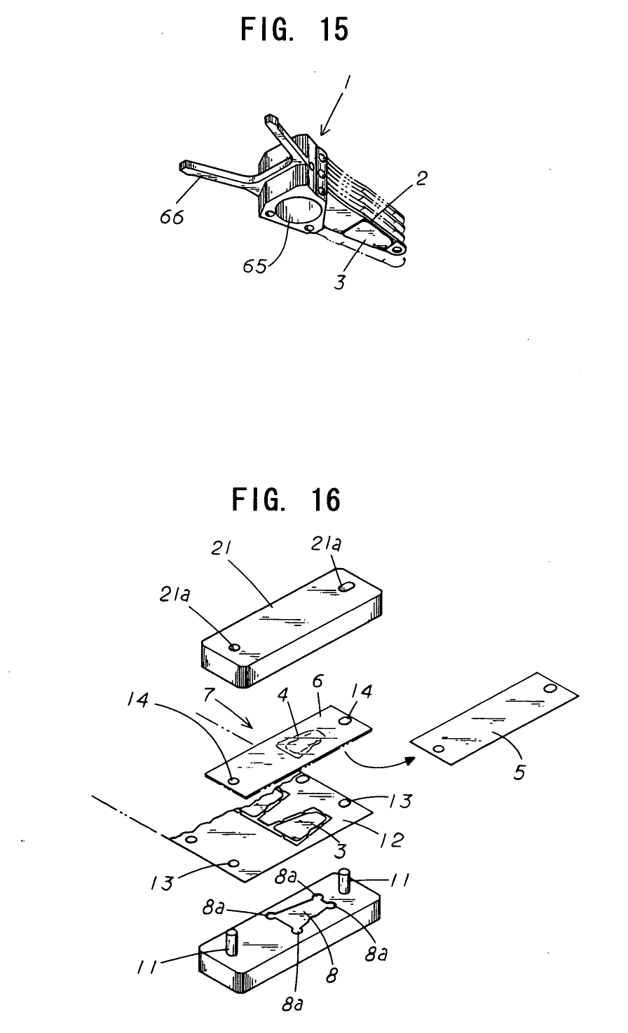

Subsequently, under this condition, when the handle 50 is depressed, the clamp member 17 depresses the top surface of the arm 2 to lower the arm 2. The lowered arm 2 is attached together to the vibration suppressing plate 3 fitted in and fixed to the recess portion 15 of the base plate 16 (see FIGS. 11 to 14). Accordingly, the vibration suppressing plate 3 may be aligned and attached to the vibration suppressing plate retaining portion 2a of the arm 2 under the condition that the arm 2 is clamped between the base plate 16 and the clamp plate 17 (see FIG. 15).

The vibration suppressing plate 3 may be arranged to a desired arm 2 in the above-described manner. Then, in the case where the vibration suppressing plates 3 are to be disposed on both upper and lower surfaces of the arm, the work may be performed by turning the magnetic disc actuator 1 upside down and setting it to the actuator supporter 31. In this case, the base plate 9 of the adhesive member applying device 20 and the base plate 16 of the vibration suppressing plate aligning and attaching device 30 are replaced by those in which recess portions 8 and 15 having different shapes are formed. Then, in the case where the both-sided adhesive member 4 is attached together to the vibration suppressing plate 3, the work is performed by peeling and removing the peelable member 6 first.

Since the present embodiment is thus constructed, it is possible to effectively and positively arrange the vibration suppressing plate 3 to the arm 2 of the magnetic disc actuator 1.

Also, in this embodiment, since the work of attaching to the vibration suppressing plate 3 the both-sided adhesive member 4 of the planar adhesive member 7 from which one of the peelable member 5 has been removed is performed precisely under the positioned condition by using the adhesive member applying device 20 having the above-described structure, the work of attaching the both-sided adhesive member 4 to the vibration suppressing plate 3 may be well performed rapidly.

Also, in this embodiment, since the work of aligning and attaching the vibration suppressing plate 3 to the arm 2 is performed precisely under the positioned condition by using the vibration suppressing plate aligning and attaching device 30 having the above-described structure, the work of aligning and attaching the vibration suppressing plate 3 to the arm 2 may be well performed rapidly.

### Embodiment 2

A specific second embodiment of the present invention will now be described with reference to the accompanying drawings.

Another means than that of the first embodiment is adopted as the means for applying to the vibration suppressing plate 3 the both-sided adhesive member 4 of the planar adhesive member 7 from which one of the peelable members 5 has been peeled and removed as shown in FIG. 16.

More specifically, a positioning member 12 is provided around the vibration suppressing plates 3, a plurality of vibration suppressing plates 3 are formed integrally in a loop shape and the vibration suppressing plate 3 is used while being separated from the positioning member 12. Such vibration suppressing plates 3 are used. Holes 13 are formed as positioning portions 13 to be fitted with convex portions 11 formed in the base plate 9 are formed in both end portions of the positioning member 12. The holes 13 of the positioning member 12 and holes 14 of the peelable member 6 are fitted with the convex portions 11 of the base plate 9 so that the both-sided adhesive member 4 of the planar adhesive member 7 from which one of the peelable member 5 has been peeled and removed is attached to the vibration suppressing plate 3.

The position member 12 is provided to the vibration suppressing plate 3 instead of using the recess portion 8 as the positioning means of the vibration suppressing plate 3 to the base plate 9. The vibration suppressing plate 3 is positioned to the base plate 9 by utilizing the holes 13 of the positioning member 12.

Thus, this embodiment is suitable for the continuous work when the vibration suppressing plate 3 having one surface to which the both-sided adhesive member 4 is provided is to be obtained.

Also, in this embodiment, in the case where burrs are formed at the cut position when the vibration suppressing plate 3 is to be removed from the positioning member 12, it is possible to remove the burrs well by utilizing the recess portion 8 of the base plate 9.

The other is the same as those of the first embodiment.

Incidentally, the present invention is not limited to the first and second embodiments, a specific structure of each component or member may be suitably designed as desired.

1. A method for arranging a vibration suppressing plate to an arm, projected from a magnetic disc actuator, for retaining a magnetic head on a tip end side, comprising the following steps of:
peeling a first one of peelable members from a planar adhesive member provided on both surfaces of a both-sided adhesive member with the peelable members, the both-sided adhesive member having the same shape as a predetermined shape of the vibration suppressing plate;
subsequently, applying, aligning and attaching to the vibration suppressing plate the planar adhesive member from which the first peelable member has been peeled and removed;
subsequently, peeling the other peeling member to form the vibration suppressing plate having one surface attached to the both-sided adhesive member; and
subsequently, aligning and attaching the vibration suppressing plate in a predetermined position of the arm to arrange the vibration suppressing plate in the arm.

2. A method for arranging a vibration suppressing plate to an arm of a magnetic disc actuator according to claim 1, wherein a means for applying, aligning and attaching to the vibration suppressing plate the planar adhesive member from which the first peelable member has been peeled and removed comprises a means for applying, aligning and attaching the vibration suppressing plate to a recess portion of a base plate for fitting and fixing the vibration suppressing plate in place.

3. A method for arranging a vibration suppressing plate to an arm of a magnetic disc actuator according to claim 2, wherein holes are formed in the peelable member, whereas convex portions with which the holes are to be engaged are formed in the base plate, and the holes are fitted with the convex portions to thereby apply, align and attach to the vibration suppressing plate the planar adhesive member from which the first peelable member has been peeled and removed.

4. A method for arranging a vibration suppressing plate to an arm of a magnetic disc actuator according to claim 1, wherein a means for applying, aligning and attaching to the vibration suppressing plate the planar adhesive member from which the first peelable member has been peeled and removed comprises a means wherein a vibration suppressing plate around which a positioning member is provided is used as the vibration suppressing plate, positioning portions are provided at the positioning member and the peelable member, and the positioning portions are aligned with each other to thereby apply, align and attach to the vibration suppressing plate the planar adhesive member from which the first peelable member has been peeled and removed.

5. A method for arranging a vibration suppressing plate to an arm of a magnetic disc actuator according to claim 4, wherein holes are formed as the positioning member of the vibration suppressing plate and the positioning portions of the peelable member, respectively, whereas convex portions with which the holes are to be engaged are formed in the base plate, and the holes are fitted with the convex portions to thereby apply, align and attach to the vibration suppressing plate the planar adhesive member from which the first peelable member has been peeled and removed.

6. A method for arranging a vibration suppressing plate to an arm of a magnetic disc actuator according to claim 1, wherein a means for aligning and attaching to a predetermined position of the arm the vibration suppressing plate having one surface to which the both-sided adhesive member is attached and for arranging the vibration suppressing plate to the arm comprises a means for arranging a base plate provided with the vibration suppressing plate at a bottom surface approaching position of the arm, subsequently approaching and moving at least one or both of the arm and the vibration suppressing plate and aligning and attaching the vibration suppressing plate to the arm.

7. A method for arranging a vibration suppressing plate to an arm of a magnetic disc actuator according to claim 1, wherein a means for aligning and attaching to a predetermined position of the arm the vibration suppressing plate having one surface to which the both-sided adhesive member is attached and for arranging the vibration suppressing plate to the arm comprises a means for arranging the base plate provided with the vibration suppressing plate to a bottom surface approaching position of the arm, arranging to the top surface approaching position of the arm a clamp plate for clamping the arm with the base plate, clamping the arm between the base plate and the clamp plate and aligning and attaching the vibration suppressing plate to the arm.

8. A method for arranging a vibration suppressing plate to an arm of a magnetic disc actuator according to claim 1, wherein a means for aligning and attaching to a predetermined position of the arm the vibration suppressing plate having one surface to which the both-sided adhesive member is attached and for arranging the vibration suppressing plate to the arm comprises a means for fitting and fixing the vibration suppressing plate to a recess portion of the base plate where the recess portion to which the vibration suppressing plate is fitted and fixed is formed, and aligning, attaching and arranging the vibration suppressing plate to the arm.

9. A method for arranging a vibration suppressing plate to an arm of a magnetic disc actuator according to claim 6, wherein a means for aligning and attaching to a predetermined position of the arm the vibration suppressing plate having one surface to which the both-sided adhesive member is attached and for arranging the vibration suppressing plate to the arm comprises a means for fitting and fixing the vibration suppressing plate to a recess portion of the base plate where the recess portion to which the vibration suppressing plate is fitted and fixed is formed, and aligning, attaching and arranging the vibration suppressing plate to the arm.

10. A method for arranging a vibration suppressing plate to an arm of a magnetic disc actuator according to claim 7, wherein a means for aligning and attaching to a predetermined position of the arm the vibration suppressing plate having one surface to which the both-sided adhesive member is attached and for arranging the vibration suppressing plate to the arm comprises a means for fitting and fixing the vibration suppressing plate to a recess portion of the base plate where the recess portion to which the vibration suppressing plate is fitted and fixed is formed, and aligning, attaching and arranging the vibration suppressing plate to the arm.

11. A method for arranging a vibration suppressing plate to an arm of a magnetic disc actuator according to claim 7, further comprising the step of arranging to the bottom surface approaching position of the arm the vibration suppressing plate fitted and fixed to the recess portion of the base plate, arranging the clamp plate for clamping the arm with the base plate in the top surface approaching position of the arm, subsequently clamping the arm between the base plate and the clamp plate and aligning, attaching and arranging the vibration suppressing plate to the arm.

12. A method for arranging a vibration suppressing plate to an arm of a magnetic disc actuator according to claim 8, further comprising the step of arranging to the bottom surface approaching position of the arm the vibration suppressing plate fitted and fixed to the recess portion of the base plate, arranging the clamp plate for clamping the arm with the base plate in the top surface approaching position of the arm, subsequently clamping the arm between the base plate and the clamp plate and aligning, attaching and arranging the vibration suppressing plate to the arm.

13. A method for arranging a vibration suppressing plate to an arm of a magnetic disc actuator according to claim 9, further comprising the step of arranging to the bottom surface approaching position of the arm the vibration suppressing plate fitted and fixed to the recess portion of the base plate, arranging the clamp plate for clamping the arm with the base plate in the top surface approaching position of the arm, subsequently clamping the arm between the base plate and the clamp plate and aligning, attaching and arranging the vibration suppressing plate to the arm.

14. A method for arranging a vibration suppressing plate to an arm of a magnetic disc actuator according to claim 10, further comprising the step of arranging to the bottom surface approaching position of the arm the vibration suppressing plate fitted and fixed to the recess portion of the base plate, arranging the clamp plate for clamping the arm with the base plate in the top surface approaching position of the arm, subsequently clamping the arm between the base plate and the clamp plate and aligning, attaching and arranging the vibration suppressing plate to the arm.

15. A method for arranging a vibration suppressing plate to an arm of a magnetic disc actuator according to claim 6, wherein the base plate is set to such a thickness that the base plate may be arranged between a plurality of juxtaposed arms.

16. A method for arranging a vibration suppressing plate to an arm of a magnetic disc actuator according to claim 7, wherein the base plate is set to such a thickness that the base plate may be arranged between a plurality of juxtaposed arms.

17. A method for arranging a vibration suppressing plate to an arm of a magnetic disc actuator according to claim 8, wherein the base plate is set to such a thickness that the base plate may be arranged between a plurality of juxtaposed arms.

18. A method for arranging a vibration suppressing plate to an arm of a magnetic disc actuator according to claim 9, wherein the base plate is set to such a thickness that the base plate may be arranged between a plurality of juxtaposed arms.

19. A method for arranging a vibration suppressing plate to an arm of a magnetic disc actuator according to claim 10, wherein the base plate is set to such a thickness that the base plate may be arranged between a plurality of juxtaposed arms.

20. A method for arranging a vibration suppressing plate to an arm of a magnetic disc actuator according to claim 11, wherein the base plate is set to such a thickness that the base plate may be arranged between a plurality of juxtaposed arms.

21. A method for arranging a vibration suppressing plate to an arm of a magnetic disc actuator according to claim 12, wherein the base plate is set to such a thickness that the base plate may be arranged between a plurality of juxtaposed arms.

22. A method for arranging a vibration suppressing plate to an arm of a magnetic disc actuator according to claim 13, wherein the base plate is set to such a thickness that the base plate may be arranged between a plurality of juxtaposed arms.

23. A method for arranging a vibration suppressing plate to an arm of a magnetic disc actuator according to claim 14, wherein the base plate is set to such a thickness that the base plate may be arranged between a plurality of juxtaposed arms.

24. A method for arranging a vibration suppressing plate to an arm of a magnetic disc actuator according to claim 6, wherein the clamp plate is set to such a thickness that the clamp plate may be arranged between a plurality of juxtaposed arms.

25. A method for arranging a vibration suppressing plate to an arm of a magnetic disc actuator according to claim 7, wherein the clamp plate is set to such a thickness that the clamp plate may be arranged between a plurality of juxtaposed arms.

26. A method for arranging a vibration suppressing plate to an arm of a magnetic disc actuator according to claim 8, wherein the clamp plate is set to such a thickness that the clamp plate may be arranged between a plurality of juxtaposed arms.

27. A method for arranging a vibration suppressing plate to an arm of a magnetic disc actuator according to claim 9, wherein the clamp plate is set to such a thickness that the clamp plate may be arranged between a plurality of juxtaposed arms.

28. A method for arranging a vibration suppressing plate to an arm of a magnetic disc actuator according to claim 10, wherein the clamp plate is set to such a thickness that the clamp plate may be arranged between a plurality of juxtaposed arms.

29. A method for arranging a vibration suppressing plate to an arm of a magnetic disc actuator according to claim 11, wherein the clamp plate is set to such a thickness that the clamp plate may be arranged between a plurality of juxtaposed arms.

30. A method for arranging a vibration suppressing plate to an arm of a magnetic disc actuator according to claim 12, wherein the clamp plate is set to such a thickness that the clamp plate may be arranged between a plurality of juxtaposed arms.

31. A method for arranging a vibration suppressing plate to an arm of a magnetic disc actuator according to claim 13, wherein the clamp plate is set to such a thickness that the clamp plate may be arranged between a plurality of juxtaposed arms.

32. A method for arranging a vibration suppressing plate to an arm of a magnetic disc actuator according to claim 14, wherein the clamp plate is set to such a thickness that the clamp plate may be arranged between a plurality of juxtaposed arms.
